(19) United States
(12) Patent Application Publication
(10) Pub. No.: US 2013/0196202 A1
(43) Pub. Date: Aug. 1, 2013

(54) METHOD AND DEVICE FOR PRODUCING AN ELECTROCHEMICAL ENERGY STORAGE CELL AND ALSO AN ENERGY STORAGE CELL

(71) Applicant: LI-TEC BATTERY GMBH, Kamenz (DE)

(72) Inventor: Joerg Kaiser, Eggenstein (DE)

(73) Assignee: LI-TEC BATTERY GMBH, Kamenz (DE)

(21) Appl. No.: 13/755,368

(22) Filed: Jan. 31, 2013

Related U.S. Application Data
(60) Provisional application No. 61/592,662, filed on Jan. 31, 2012.

(30) Foreign Application Priority Data
Jan. 31, 2012 (DE) 10 2012 001 806.1

(51) Int. Cl. H01M 10/04

(52) U.S. Cl. CPC H01M 10/0404; H01M 10/04; H01M 10/0431; H01M 10/0409
USPC 429/94; 29/623.1; 29/730; 429/163

(57) ABSTRACT

The invention relates to a method and a corresponding device for producing an electrochemical energy storage cell which exhibits at least one electrode stack (10) and/or electrode coil and a casing (20) at least partially surrounding the electrode stack or electrode coil, respectively, wherein the energy storage cell is at least partially filled with electrolyte (30) and a massaging movement is exerted on the casing (20) which at least partially surrounds the electrode stack (10) or electrode coil.

The present invention relates to a method and a corresponding device for producing an electrochemical energy storage cell and a corresponding energy storage cell according to the preamble of the independent claims.

Energy storage cells known in the art, which are also referred to as electrochemical cells or galvanic cells, exhibit an electrode stack or electrode coil surrounded by a housing or a casing. The electrode stack usually has a plurality of electrode groups composed of two electrodes in each case, having a separator layer located therebetween, which is capable of holding an electrolyte, said electrode groups being arranged or stacked alongside or above one another. In an electrode coil, at least one electrode group is usually wound into a so-called coil. The electrodes of electrode groups with the same polarity are electrically connected to a current collector in each case, via which the electrical voltage generated in the cell can be tapped from the outside.

When producing energy storage cells, the stacked or coiled electrode groups are initially inserted into or encased in a preferably pouch-shaped or can-shaped casing, before said casing is filled with electrolyte and then sealed.

The problem addressed by the present invention is that of indicating an improved method and corresponding device for producing an electrochemical energy storage cell.

This problem is solved by the method and the device for producing an electrochemical energy storage cell according to the independent claims.

In the method according to the invention for producing an electrochemical energy storage cell, which exhibits at least one electrode stack and/or electrode coil and a casing at least partially surrounding the electrode stack or electrode coil, respectively, the energy storage cell is at least partially filled with electrolyte. The method is characterized in that a massaging movement is exerted on the casing which at least partially surrounds the electrode stack or electrode coil, respectively.

The device according to the invention for the production of an electrochemical energy storage cell, which contains at least one electrode stack and/or electrode coil and a casing at least partially surrounding the electrode stack or electrode coil, respectively, exhibits a filling unit in which the energy storage cell can be at least partially filled with electrolyte and is characterized by at least one massaging element, which can exert a massaging movement on the casing at least partially surrounding the electrode stack or electrode coil, respectively.

An electrochemical energy storage cell according to the invention is characterized in that it is produced by the method according to the invention and/or in the device according to the invention.

An electrochemical energy storage cell according to the invention exhibits at least one electrode stack and/or electrode coil, a casing at least partially surrounding the electrode stack or electrode coil, respectively, and an electrolyte contained within the casing and is characterized in that the casing at least partially surrounding the electrode stack or electrode coil, respectively, is configured such that when a massaging movement is exerted on the casing from outside, locally variable and/or time-variable pressures occur within the casing. The casing is preferably designed in this case such that, on the one hand, it is sufficiently thin to be adequately strongly deformable, so that the locally variable and/or time-variable pressures applied to the casing from outside can be transmitted into the inside of the casing. On the other hand, the casing must be sufficiently thick and robust in design so that it is not damaged and/or detrimentally affected by material fatigue during the massaging movement.

The basic idea underlying the invention is that of massaging the energy storage cell, which is at least partially filled with electrolyte, from outside, wherein the locally variable pressures produced during the massaging movement cause the electrode stack or electrode coil, respectively disposed within the casing likewise to be exposed to corresponding locally variable pressures. By this means, any gases, particularly gas bubbles, which can seriously affect the function of the finished energy storage cell, are expelled from the energy storage cell, particularly from the electrolytes and/or separator layers, highly efficiently, which results in an extremely homogeneous distribution of the electrolyte between the electrodes and therefore considerably improves the functionality of the energy storage cell. The method according to the invention and the corresponding device therefore allow for a more efficient manufacture of electrochemical energy storage cells than is the case with the methods and devices known in the art.

A massaging movement exerted on the casing of the energy storage cell within the meaning of the present invention refers to any impact on the casing from outside, in which said casing is exposed to locally variable and/or time-variable pressures, particularly excess pressures and/or negative pressures, which are preferably caused by mechanical contact. Excess pressure or negative pressure within this meaning exists particularly when the local pressure applied to an area of the casing is greater or smaller than the ambient pressure in which the casing is filled or the massaging movement takes place. In particular, when the casing comes into contact with at least one massaging element in the region of the contact areas between the massaging element and the casing, normal forces and, as a result of these, frictional forces occur, by means of which a movement of the massaging element results in locally variable and/or time-variable pressures on the casing. The frictional forces are preferably rolling frictional forces and/or sliding frictional forces and/or static frictional forces, in which the massaging element, or at least a part thereof in the case of rolling friction, is rolled on the casing and higher pressures are thereby applied to the casing in the region of the respective contact area than outside this area. In the case of sliding friction, the massaging element, or at least part thereof, moves on the casing relative thereto, thereby applying higher pressures to the casing in the region of the respective contact area than outside these areas. This also applies accordingly to static friction. A massaging movement within the meaning of the invention therefore relates to any massaging, kneading or fulling of the casing and/or of the electrochemical energy storage cell.

Apart from mechanical contact, a massaging movement within the meaning of the present invention can also be generated, for example, by exposing the casing of the energy storage cell from outside to locally variable gas pressures, for example by spraying the casing with one or a plurality of jets emerging from one or a plurality of nozzles of a compressed, preferably inert, gas, e.g. air, carbon dioxide or nitrogen which, in the area where it impinges on the casing, presses said casing in the direction of the electrode stack or electrode coil, respectively, disposed within the casing. In order to generate the “kneading effect” characteristic of the massaging movement, the nozzles are preferably controlled in this case, such that they do not all emit compressed gas onto the casing simultaneously, but alternately in time.

An electrochemical energy storage cell within the meaning of the invention is understood to be an electrochemical energy store, in other words, a device which stores energy in chemical form, delivers it to a consumer in electrical form and is preferably also able to receive it in electrical form from a charging device. Important examples of such electrochemical energy stores are galvanic cells or fuel cells. The electrochemical cell has at least a first and a second device for storing electrically different charges, as well as a means of producing an active electrical connection between these two aforementioned devices, wherein charge carriers can be inserted between these two devices. The means of producing an active electrical connection should be understood to be an electrolyte, for example, which acts as an ion conductor.

An electrode arrangement completely surrounded by a casing is also referred to as a preliminary product of an electrochemical cell. A casing in this context is understood to be a device which prevents chemicals from escaping from the electrode arrangement into the environment. Furthermore, the casing can protect the chemical components of the electrode arrangement from unwanted interaction with the environment. The casing preferably protects the electrode arrangement from the ingress of water or water vapour from the environment. The casing is preferably configured as a film. The casing should impede the passage of thermal energy as little as possible. The casing preferably comprises at least two formed parts.

An electrode arrangement or electrode group should be understood to mean an arrangement of at least two electrodes and an electrolyte disposed therebetween. The electrolyte may be partially contained by a separator. The separator then separates the electrodes. The electrode arrangement or electrode group is also used to store chemical energy and convert it into electrical energy. In the case of a rechargeable galvanic cell, the electrode arrangement or electrode group is also capable of converting electrical energy into chemical energy. The electrodes are preferably configured in plate form or in a film-like manner. The electrodes in the electrode arrangement or the electrode group are preferably arranged in stacks. According to another preferred embodiment, the electrodes may also be wound. The electrode arrangement may preferably comprise lithium or another alkali metal also in ionic form.

The energy storage cell according to the invention is preferably a flat energy storage cell, this being understood to mean an electrochemical cell, the outer form of which is characterized by two essentially parallel surfaces, the perpendicular distance thereof from one another being shorter than the mean length of the cell measured parallel to these surfaces. The electrochemically active constituents of the cell, preferably encased in packaging or a cell housing, are arranged between these surfaces. Cells of this kind are frequently surrounded by multi-layer film packaging, which has a sealed seam on the edges of the cell packaging, said seam being formed by a permanent connection or sealing of the film packaging in the area of the sealed seam. Cells of this kind are frequently also referred to as pouch cells or coffee bag cells.

At least one side wall of the casing is preferably exposed to the massaging movement by locally variable pressures. With this heterogeneous pressure distribution over the respective side wall of the casing, one or a plurality of areas of the side wall is/are exposed to higher pressures than the other areas of said side wall. The pressure distribution thereby achieved propagates within the energy storage cell, wherein the emergence of possible gas bubbles from the energy storage cell being promoted in a particularly efficient way.

It is further preferable for the locally variable pressures in the area of at least one side wall of the casing to be time-variable. The heterogeneous pressure distribution via the respective side wall of the casing is also subject in this case to temporal changes, so that at a first point in time, one or a plurality of first areas of the side wall are exposed to higher pressures than the remaining areas of this side wall at the first point in time and at a second point in time, one or a plurality of second areas of the side wall, which differ from the first areas of the side wall, are exposed to higher pressures than the other areas of the side wall at the second point in time. The expulsion of any gases from the energy storage cell is thereby facilitated in a particularly efficient manner.

In a further preferred embodiment of the invention, the massaging movement is exerted on two opposite side walls of the casing simultaneously. This leads to a very rapid and—relative to the cross-section of the electrode stack or coil, respectively,—particularly homogeneous elimination of any gases or gas bubbles from the cell.

It is further preferred for the massaging movement to be exerted during the filling of the energy storage cell with electrolyte. In this way, a rapid distribution of electrolyte fluid in the electrode stack or coil, respectively, is already achieved during filling, this also being referred to as wetting and, moreover, the formation of gas bubbles is suppressed or at least greatly reduced. A separate step for the elimination of gas bubbles from the filled energy storage cell can therefore be dispensed with, which facilitates a particularly efficient production of energy storage cells.

In a further preferred embodiment of the invention, the massaging movement is exerted while the energy storage cell is located in an environment in which the prevailing pressure is lower than the atmospheric pressure. In this way, an emergence of gas bubbles mobilized by means of the massaging movement at the open side of the casing is promoted, which makes the production of the energy storage cells even more efficient.

The massaging movement is preferably performed by at least one massaging element moved in at least two spatial dimensions. The massaging element in this case is, for example, continuously moved perpendicularly up to the casing and away from it (first dimension), thereby moving simultaneously in at least one direction (second dimension) running parallel to the casing. Alternatively or in addition to the second dimension, the massaging element may be moved simultaneously in a further direction (third dimension) running parallel to the casing.

It is preferable in this case for the massaging movement to be exerted by way of a circular movement in a plane running essentially parallel to one of the side walls of the casing. The circular movement in this case is constituted by superimposing a movement of the massaging element in a direction (second dimension) running parallel to the casing and a further direction (third dimension) running parallel to the casing, while the massaging element in the third dimension is not moved in the direction of the casing. An additional movement component in the third dimension may be preferable, however, and leads to an even greater efficiency when expelling gas bubbles compared with a pure circular massaging movement.

The movements of the massaging elements indicated above are movements with so-called linear movement components along the x, y or z axis. Alternatively or in addition to this, it is also possible and preferable, however, for one or a plurality of rotational movement components to be provided in the massaging movement. In this case, the massaging movement is exerted by at least one massaging element, which is tilted during the massaging movement, preferably periodically, by a predetermined angle about at least one rotational axis. For example, the massaging element may tilted periodically within a predetermined angle range, e.g. between +5° and −5°, about a rotational axis, for example in an x and/or y and/or z direction. Through a rotational movement of the massaging element of this kind, a particularly efficient massaging of the casing is achieved, for example in combination with a linear movement component.

It is further preferred for the massaging movement to be exerted by at least one massaging element which is in contact with the casing during massaging, whereupon in the region of one or a plurality of contact areas between the massaging element and the casing, normal forces and frictional forces resulting therefrom, particularly rolling frictional forces and/or sliding frictional forces and/or static frictional forces occur. By using rotatable rollers or balls, for example, or massaging elements sliding on or adhering to the casing, locally variable and/or time-variable pressures are generated on the casing easily and reliably through the massaging movement of the massaging element, due to the frictional forces occurring in the region of the contact areas.

The massaging movement is preferably exerted by at least one massaging element, which is arranged and configured relatively to the casing during the massaging movement, such that it exhibits a contour on the side facing a side wall of the casing. In this way, an effective massaging movement can be easily achieved.

It is preferable in this case for the massaging element to be arranged and configured relative to the casing during the massaging movement, such that the contour exhibits at least one elevation facing the side wall of the casing and/or at least one indentation facing away from the side wall of the casing. By means of a contour configured in this manner, an expulsion of gas bubbles from the inside of the energy storage cell can be achieved particularly easily and efficiently.

The indentation facing away from the side wall of the casing may preferably be configured in the form of a suction element, particularly a so-called suction cup, which sucks onto the casing upon contact therewith and is thereby detachably connected thereto. Through movements of the massaging element about a given path away from the casing, said casing is slightly outwardly deformed, at least in the area of the sucked-on suction element, so that a local negative pressure occurs within the casing, at least in the area of this deformation. The casing may thereby be easily exposed not only to excess pressures, but also to negative pressures, as a result of which a highly effective massaging of the casing by means of locally and/or time-variable excess pressures and negative pressures is achieved.

In a further preferred embodiment of the invention, the massaging movement is exerted by at least one massaging element, which exhibits a surface formed convexly with respect to a side wall of the casing. By means of a surface of the massaging element formed in this manner, the massaging movement is facilitated in a particularly robust and reliable manner.

It is moreover preferable for the massaging movement to be exerted by at least one massaging element, which exhibits at least one elastic element, particularly in the form of a cushion, on the side facing a side wall of the casing during the massaging movement. By means of the elastic element, the casing is on the one hand protected during the massaging movement and, on the other hand, a particularly efficient “kneading” or “fulling” of the casing is made possible.

Further advantages, features and possible applications of the present invention will be apparent emerge from the following description in connection with the figures. In the figures:

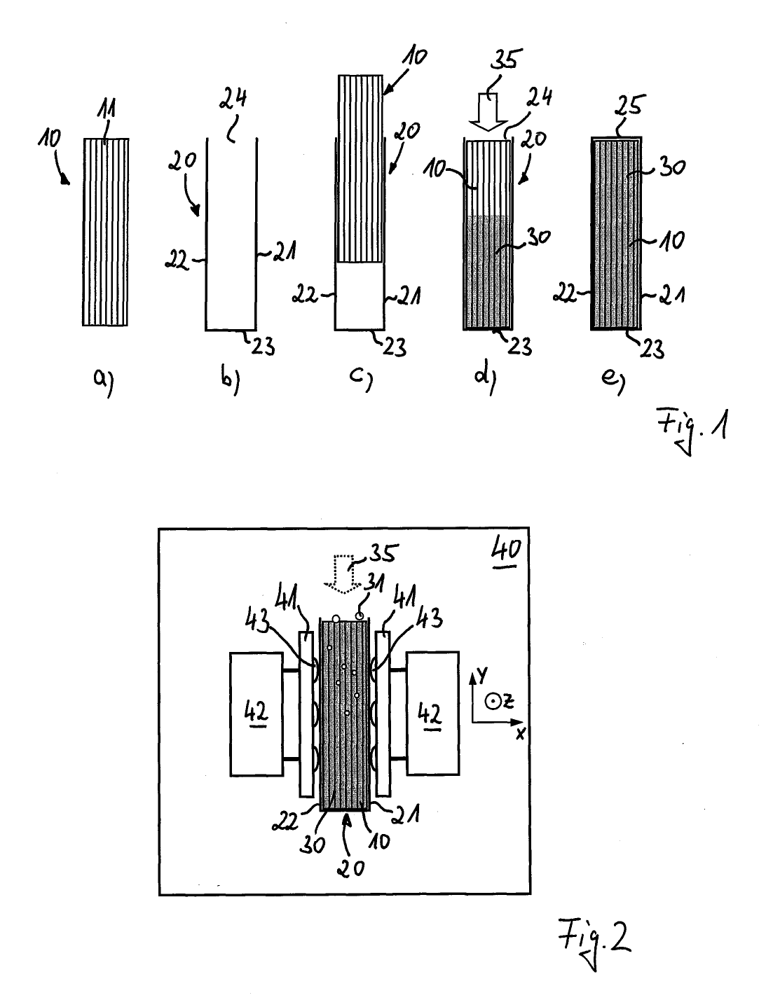

FIG. 1 shows an example to illustrate individual steps of the process according to the invention;

FIG. 2 shows an example of a device according to the invention in a cross-sectional representation;

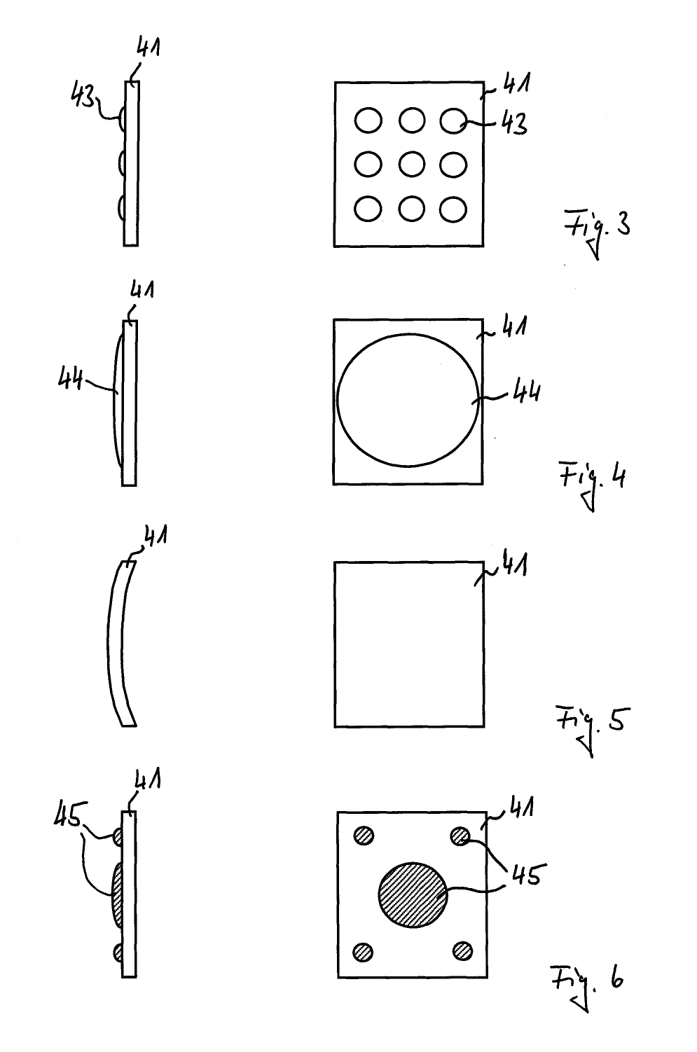

FIG. 3 shows a first example of a massaging element;

FIG. 4 shows a second example of a massaging element;

FIG. 5 shows a third example of a massaging element;

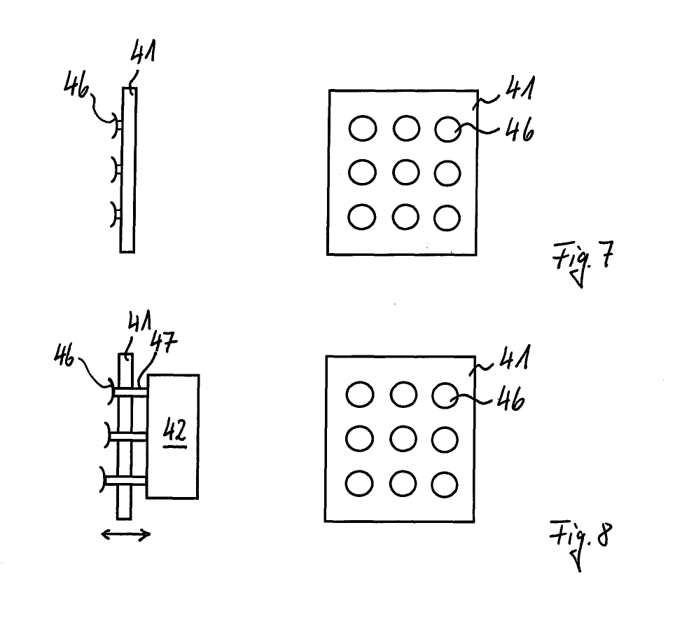

FIG. 6 shows a fourth example of a massaging element;

FIG. 7 shows a fifth example of a massaging element;

FIG. 8 shows a sixth example of a massaging element.

FIG. 1 shows an example to illustrate individual steps of the method according to the invention.

In a step a), two or a plurality of electrode groups 11 are stacked into an electrode stack 10. Each of the electrode groups 11 in this case has two electrodes configured in planar fashion and also a separator layer disposed between the two electrodes, said separator layer being able to receive an electrolyte. Between the individual electrode groups 11 is provided in addition a separator layer or an insulation layer.

Alternatively, instead of the electrode stack, a so-called electrode coil may be produced, by winding a coil layer composed of two electrode layers, a separator layer disposed therebetween and a separator or insulation layer disposed on at least one of the two electrode layers about a coil core. The so-called round coil thereby achieved may be subsequently changed into an approximately ashlar-shaped or prismatic form, the cross-section of which is similar to the cross-section of the depicted electrode stack 10.

In a further step b) a casing 20 is produced, which is able to hold the electrode stack 10 produced in step a) or a correspondingly formed electrode coil. The casing 20 exhibits two side walls 21 and 22 running parallel to one another, a bottom wall 23 and also two face side walls extending parallel to the drawing plane and not visible in the chosen cross-sectional representation. The top side 24 of the casing 20 disposed opposite the bottom wall 23 remains open initially.

In a further step c), the electrode stack 10 is then introduced through the open upper side 24 into the inside of the casing 20, until said electrode stack 10 comes to rest in the area of the bottom wall 23 of the casing 20.

This state is depicted in step d), in which the inside of the casing 20 is filled with electrolyte fluid 30 through the open top side 24. A suitable filling unit 35 is used to fill the electrolyte fluid 30, said filling unit being indicated in the example shown solely by means of an arrow. The electrolyte fluid 30 is preferably a fluid which contains lithium ions. In particular, the electrolyte fluid 30 is a conducting salt, for example a lithium salt, dissolved in a solvent.

In a further step e), the casing 20 completely filled with electrolyte fluid 30 is provided with a cover 25 on its originally open upper side 24 and sealed in a gas-tight and/or liquid-tight manner. For reasons of clarity, the additional representation of electrical arrester lugs, which are conducted from the electrode stack 10 outwardly through the casing 20, has been dispensed with in the energy storage cell shown in FIG. 1.

During and/or after the filling of the casing 20 with electrolyte fluid 30 in step d) and before the covering and sealing of the casing 20 in step e), said casing is exposed to a massaging movement from outside in the manner according to the invention, in order to eliminate any unwanted gas inclusions in the electrolyte fluid 30 or in the electrode stack 10 wetted by the electrolyte fluid 30. This is explained in greater detail below.

FIG. 2 shows an example of a device according to the invention in cross-sectional representation. The casing 20 at least partially filled with electrolyte fluid 30 with the electrode stack 10 located therein is clamped between two massaging elements 41, which are each driven by a drive mechanism 42.

The massaging elements 41 in the example shown are essentially planar plates, which run parallel to the two side walls 21 and 22 of the casing 20 and exhibit a plurality of elevations 43 on their side facing the respective side wall 21 or 22.

The massaging elements 41 are displaced by the associated drive mechanisms 42 in a movement which exhibits preferably periodic movement components in at least two or three spatial directions x, y and z simultaneously (in the chosen representation, the z direction runs perpendicular to the drawing plane).

For example, the massaging elements 41 move in a manner which exhibits movement components in the y and z direction, whereby a circular or elliptical movement in the y-z plane, in other words substantially parallel to the side walls 21 and 22 of the casing 20, results. In addition to the movement in the y-z plane, a movement component in the x direction may be provided, through which the massaging element 41 is periodically moved towards the side wall 21 or 22 of the casing 20 and away therefrom.

Alternatively, it is also possible for a movement with movement components in the x and z direction to be generated, in which the massaging element 41 is periodically pressed in the x-z plane on a circular or elliptical path onto the side wall 21 or 22 of the casing 20, conducted along said casing 20 and moved slightly away again.

The massaging movements of the massaging elements 41 described above contain only linear movement components along the x, y or z axis. Alternatively or in addition to this, the massaging movement may however also contain one or a plurality of rotational movement components. In this case, at least one of the massaging elements 41 is preferably periodically tilted by a predetermined angle about at least one rotational axis during the massaging movement. The respective rotational axis in this case runs preferably parallel to one of the three spatial axes drawn in FIG. 2 in an x, y or z direction. For example, the massaging elements 41 are periodically tilted in a predetermined angle range, e.g. between +5° and −5°, about the vertical layer shown in FIG. 2 about a rotational axis running in an x and/or y and/or z direction. Through a rotational movement of the massaging elements 41 of this kind, a particularly efficient massaging of the casing 20 is achieved, possibly combined with a linear movement component.

In the embodiments described above for generating the massaging movement, the side surfaces 21 and 22 of the casing 20 are contacted by the elevations 43 of the massaging element 41, wherein normal forces and frictional forces resulting therefrom occur in the region of one or a plurality of contact areas between the elevations 43 and the side surfaces 21 and 22 of the casing 20. Depending on the nature of the movement, these are sliding frictional forces and/or static frictional forces and, if rotatable rollers or balls, for example, are used as an alternative to or in addition to the elevations 43, rolling frictional forces. The aforementioned frictional forces help to generate locally and/or time-variable pressures on the casing.

In the case of the massaging movement of the massaging elements 41 with linear and/or rotatable movement components described above, the movement components chosen in each case are small enough, on the one hand, for the side walls 21 and 22 of the casing 20 not to be pressed in too strongly and possibly damaged as a result and, on the other hand, are sufficiently deformable for the massaging movement applied to the outside of the casing 20 to be transmitted into the inside of the casing 20 to the electrode stack 10.

When the massaging movement is transmitted to the electrode stack 10, the side walls 21 and 22 of the casing 20 are exposed to locally variable pressures and corresponding minor deformations, which are passed on to the electrode stack 10 located within the casing 20 and likewise expose the electrode stack 10 to time-variable pressures and deformations. In turn, the latter mean that the electrolyte fluid 30 contained by the electrode stack 20 is likewise exposed to locally and time-variable pressures, which particularly result in an expulsion from the electrode stack 10 of any gas that may be present in the electrolyte fluid 30 in the form of gas bubbles 31.

As a result of the massaging movement of the massaging elements 41, particularly in conjunction with correspondingly configured massaging elements 41, an efficient expulsion of any gases, particularly in the form of gas bubbles 31, from the energy storage cell filled with electrolyte fluid 30, is easily achieved.

The massaging of the casing 20 preferably takes place even during filling with the electrolyte fluid 30 by means of a filling unit 35, which is indicated in FIG. 2 by a dotted arrow. A massaging of the casing 20 during filling with the electrolyte fluid 30 (cf. step d) in FIG. 1) has the particular advantage that, on the one hand, a particularly homogeneous distribution of electrolyte fluid is achieved even during filling and, on the other hand, an inclusion of gas, particularly in the form of gas bubbles 31, can be prevented or at least reduced during filling. Additional massaging of the completely filled casing 20 can thereby be dispensed with completely or at least drastically reduced in terms of timing, leading to a significant acceleration in the production process overall.

The filling of the casing 20 with the electrode stack 10 located therein and/or the massaging of the casing 20 by means of the massaging elements 41 preferably takes place in a vacuum chamber 40 (only indicated schematically in FIG. 2), in which a reduced gas pressure prevails relative to the atmospheric pressure (approx. 1 bar). The inclusion of gas bubbles 31 during filling is thereby further reduced and the expulsion of gases in the form of gas bubbles 31 thereby becomes even more efficient.

FIG. 3 shows a first example of a massaging element 41 in side view (left figure part) and front view (right figure part). The massaging element 41 in this example exhibits an essentially planar baseplate with elevations 43 configured in matrix-like form thereon. The total of nine elevations 43 are identical in design in the example shown and are rounded on their distal end relative to the baseplate. The rounding has the advantage that with the massaging movement exerted on the side surfaces 21 and 22 of the casing 20, pressure peaks are avoided, which could likewise result in damage to the casing 20. The massaging element 41 may be designed as a single piece, i.e. the substantially planar baseplate and the elevations 43 located thereon are formed from a single piece. Alternatively, it is also possible, however, for elevations 43 to be applied to the baseplate subsequently, i.e. by adhesion, screwing or welding. It is also possible in principle for the individual elevations 43 to be differently configured. Hence, depending on the particular application, it may be advantageous for a different diameter to be chosen for the circular elevations 43 shown in the example and/or a different height thereof above the baseplate.

FIG. 4 shows a second example of a massaging element 41, which instead of a plurality of elevations 43 (cf. FIG. 3) only exhibits a single elevation in the form of a surface 44 curved convexly in two spatial directions. In the example shown, the convexly curved surface 44 is applied to the baseplate of the massaging element 41 configured substantially in planar form. Alternatively, it is also possible, however, for the baseplate of the massaging element 41 itself to be configured as a convexly formed surface.

FIG. 5 shows a third example of a massaging element 41, which is convexly curved in only one spatial direction and therefore has the form of a bent strip or belt. Despite the particularly simple embodiment, highly efficient massaging movements can be performed with this massaging element 41 onto the casing 20 of the energy storage cell.

FIG. 6 shows a fourth example of a massaging element 41, in which a plurality of elastic elements 45 is applied to the baseplate of the massaging element 41, said baseplate having a substantially planar configuration. The elastic elements 45 preferably have the form of rounded cushions which, on the one hand, are soft enough to yield on contact with the outside of the casing 20 and, on the other hand, are firm enough to cause the locally variable deformation of the side walls 21 and 22 and the casing 20 required during the massaging movement.

In the example shown in FIG. 6, a total of five elastic elements 45 are provided, wherein four smaller elements are arranged in the area of the corners of the baseplate of the massaging element 41, which is substantially planar in design, and a larger element is arranged in the centre of the smaller elements. Since the elastic elements 45 are partially pressed together during the massaging movement, these are preferably configured higher than the elevations 43 or 44 of substantially non-elastic design shown in FIGS. 3 and 4, for example.

By means of the embodiments of the massaging elements 41 described above, it is possible for the side walls 21 or 22 of the casing 20 to be exposed to locally differing pressures, when the massaging elements 41 press on the side walls. As a result, in those areas in which the elevations 43 or elastic elements 45 press on the side wall 21 or 22 of the casing 20, higher pressures prevail than in the areas between the elevations 43 or elastic elements 45. The same applies to the massaging elements 41 with a convexly formed surface 44, in which a higher pressure is applied to the side wall 21 or 22 in the area of the apex (FIG. 4) or the crown line (FIG. 5) than in the areas to the side of the apex.

By performing the massaging movements described above with massaging elements 41 of this kind, it is possible for the locally variable pressures exerted on a side wall 21 or 22 of the casing 20 in each case to be time-variable, the pressure on at least one area of the side wall 21 or 22 being greater or smaller at a first point in time than the pressure on this area at a second point in time. If, for example, the massaging element 41 shown in FIG. 3 is periodically tilted about a rotational axis running parallel to the z-axis (see FIG. 2), so that the upper three elevations 43 are pressed against the side wall 21 or 22 of the casing 20 more strongly at a first point in time and more weakly at a second point in time than the bottom three elevations 43, the pressures in the area of the upper three elevations 43 are greater at the first point in time and smaller at the second point in time than in the area of the lower three elevations. The same also applies to a massaging movement with linear movement components, wherein a temporal change in the pressure distribution can arise not only in the case of massaging movements with a movement component in the x-direction, but can also originate from a movement of the elevations 43 parallel to the side walls 21 or 22, for example with a movement in the y-z plane.

FIG. 7 shows a fifth example of a massaging element 41, which exhibits indentations 46 in the form of suction elements, which are sucked onto one of the side walls 21 or 22 of the casing 20 on making contact therewith, due to a negative pressure compared with the atmospheric pressure, and thereby create a detachable connection between the massaging element 41 and the casing 20. The indentations are preferably secured by means of a suitable connection (not shown) to the baseplate of the massaging element 41. The suction elements are preferably configured as suction cups, which are made of an elastic material, e.g. rubber or silicon, and upon contact with or when drawing close to the side wall 21 or 22 adhere thereto, on account of the negative pressure occurring during this. The side wall 21 or 22 of the casing 20 in this case is preferably planar and/or smooth in configuration, such that a negative pressure can be created and held at least for the period of the massaging.

Through this suction connection between the massaging element 41 and the casing 20, not only can locally and/or time-variable excess pressures be applied to said casing 20, but also locally and/or time-variable negative pressures. Hence, correspondingly designed massaging elements 41 can only be moved periodically in the x direction (see FIG. 2) towards the casing 20 and away again and an efficient expulsion of any gases from the electrolyte 30 can be brought about by the local pressure fluctuations between excess pressures and negative pressures (suction) in this case in the areas of the indentations 46.

In principle, however, movements of the massaging elements 41 with linear movement components can also be carried out in other or additional spatial directions and/or with rotational movement components. In addition, a different number, arrangement, size and height of the indentations can be chosen. The above embodiments apply accordingly in connection with the FIGS. 2 to 6 in each case.

FIG. 8 shows a sixth example of a massaging element 41, which likewise exhibits indentations 46 in the form of suction elements. Unlike the example shown in FIG. 7, the indentations 46 are fitted to tappets 47, which can be displaced by the drive mechanism 42 (see also FIG. 2) in a preferably periodic, linear movement in the direction indicated by the double arrow.

The drive mechanism 42 is preferably configured such that the tappets 47 can be moved by different paths in each case in the direction of the casing 20 or away therefrom. This is schematically illustrated in the example shown in FIG. 8, in which it can be recognized that the lower indentations 46 in each case were moved further in the direction of the side wall 21 or 22 of the casing 20 than the upper indentations 46 in each case.

The drive mechanism 42 may preferably drive the tappets 47 in such a manner that they are then moved by different distances in the reverse sequence at a later point in time, so that the upper indentations 46 in each case are moved further in the direction of the side wall 21 or 22 than the lower indentations.

The movement process described above is preferably periodic and may also be applied alternatively or additionally to the indentations 46 located at the side (see the right part of the FIG. 8), whereupon the indentations 46 disposed on the left are pushed further in the direction of the side wall 21 or 22 at a first point in time than the indentations 46 disposed on the right and at a second point in time the indentations 46 disposed on the right in each case are pushed further in the direction of the side wall 21 or 22 than the indentations 46 on the left in each case.

In relation to the further preferred possible embodiments of the indentations 46 and the movements thereof during the massaging of the casing 20, the elucidations in connection with FIG. 7 apply accordingly.

By using the massaging elements 41 described in greater detail above in the method according to the invention or in the device according to the invention, respectively, a particularly efficient elimination of gases present in the electrolyte fluid 30, particularly in the form of gas bubbles 31, is achieved in a simple manner.

1. A method for producing an electrochemical energy storage cell exhibiting at least one electrode stack and/or electrode coil and a casing at least partially surrounding the electrode stack or electrode coil, respectively, wherein the energy storage cell is at least partially filled with electrolyte, the method comprising:
exerting a massaging movement on the casing which at least partially surrounds the electrode stack or electrode coil, respectively.

2. The method according to claim 1, wherein by the massaging movement locally variable pressures are exerted on at least one side wall of the casing.

3. The method according to claim 2, wherein the locally variable pressures are time-variable.

4. The method according to claim 1, wherein the massaging movement is exerted simultaneously on two opposite side walls of the casing.

5. The method according to claim 1, wherein an escape of possible gases, particularly in the form of gas bubbles, from the inside of the energy storage cell is promoted by the massaging movement.

6. The method according to claim 1, wherein the massaging movement is exerted during the filling of the energy storage cell with electrolyte.

7. The method according to claim 1, wherein the massaging movement is exerted while the energy storage cell is located in an environment in which the prevailing pressure is lower than the atmospheric pressure.

8. The method according to claim 1, wherein the massaging movement is exerted by at least one massaging element, which is moved in at least two spatial dimensions (x, y, z).

9. The method according to claim 8, wherein the massaging movement is exerted by a movement in a plane (y-z), which runs substantially parallel to one of the side walls of the casing.

10. The method according to claim 1, wherein the massaging movement is exerted by at least one massaging element, which is tilted during the massaging movement by a predetermined angle about at least one rotational axis.

11. The method according to claim 1, wherein the massaging movement is exerted by at least one massaging element, which is in contact with the casing, wherein in the region of one or a plurality of contact areas between the massaging element and the casing, normal forces and frictional forces resulting therefrom, particularly rolling frictional forces and/or sliding frictional forces and/or static frictional forces occur.

12. The method according to claim 1, wherein the massaging movement is exerted by at least one massaging element which exhibits a contour on the side facing a side wall of the casing.

13. The method according to claim 12, wherein the contour exhibits at least one elevation and/or at least one indentations.

14. The method according to claim 1, wherein the massaging movement is exerted by at least one massaging element, which exhibits a surface formed convexly with respect to a side wall of the casing.

15. The method according to claim 1, wherein the massaging movement is exerted by at least one massaging element, which exhibits at least one elastic element, particularly in the form of a cushion, on the side facing a side wall of the casing during the massaging movement.

16. A device for the production of an electrochemical energy storage cell exhibiting at least one electrode stack and/or electrode coil and a casing at least partially surrounding the electrode stack or electrode coil, respectively, with a filling unit in which the energy storage cell can be at least partially filled with electrolyte, the device comprising:
at least one massaging element, which can exert a massaging movement on the casing at least partially surrounding the electrode stack or electrode coil, respectively.

17. An electrochemical energy storage cell produced by a method according to claim 1.

18. An electrochemical energy storage cell comprising:
at least one electrode stack and/or electrode coil;
a casing at least partially surrounding the electrode stack or electrode coil, respectively; and
an electrolyte located inside the casing,
wherein the casing at least partially surrounding the electrode stack or electrode coil, respectively, is configured such that when a massaging movement is exerted on the casing from outside, locally variable and/or time-variable pressures occur within the casing.
